(19) United States
(12) Patent Application Publication
(10) Pub. No.: US 2026/0107068 A1
(43) Pub. Date: Apr. 16, 2026

(54) Image processing method and image sensor

(71) Applicant: NOVATEK Microelectronics Corp., Hsin-Chu (TW)

(72) Inventors: Ming-Teng Huang, Hsinchu City (TW); Shen-Fu Tsai, Taoyuan City (TW)

(73) Assignee: NOVATEK Microelectronics Corp., Hsin-Chu (TW)

(21) Appl. No.: 19/074,458

(22) Filed: Mar. 10, 2025

(30) Foreign Application Priority Data
Oct. 16, 2024 (TW) 113139247

(51) Int. Cl. H04N 23/73; H04N 23/71

(52) U.S. Cl. CPC H04N 23/73; H04N 23/71

(57) ABSTRACT

An image processing method includes performing an exposure in a sensing region of an image sensor by using multiple different exposure times to generate image data with multiple exposure times; calculating multiple average luminance values according to the image data with multiple exposure times; and determining an optimal exposure time according to the multiple average luminance values. The sensing region is divided into multiple sub-regions along a vertical direction and two adjacent sub-regions correspond to different exposure times. Each average luminance value corresponds to one of the multiple different exposure times.

### BACKGROUND OF THE INVENTION

### 1. Field of the Invention

The invention relates to an image processing method applicable to an image capture device, more particularly an image processing method for fast automatic exposure.

### 2. Description of the Prior Art

With the rapid development of image processing technology, image capture devices (such as cameras) are becoming increasingly diverse in their applications. For example, hunting cameras, trail cameras, and video doorbells not only are equipped with Passive InfraRed (PIR) sensors, but also include cameras capable of recording images when an object is detected approaching.

In these applications, cameras are typically in a powered-off or sleep state to conserve power. When the infrared sensor detects an object approaching or other events worth recording, the camera must start up quickly to capture photos or videos in real-time.

For scenarios requiring cameras to start up quickly for photography or videography, how to enable the camera to rapidly generate the first image with correct luminance (or, brightness) and color is a crucial challenge. Therefore, there is a need for an image processing method to achieve fast automatic exposure (fast AE).

### SUMMARY OF THE INVENTION

According to an embodiment of the invention, an image processing method comprises: performing an exposure in a sensing region of an image sensor by using a plurality of different exposure times to generate image data with multiple exposure times, wherein the sensing region is divided into a plurality of sub-regions along a vertical direction, and two adjacent sub-regions correspond to different exposure times; calculating a plurality of average luminance values according to the image data with multiple exposure times, wherein each average luminance value corresponds to one of the plurality of different exposure times; and determining an optimal exposure time according to the plurality of average luminance values.

According to an embodiment of the invention, an image sensor comprises an image sensor array, a readout circuit and a control logic. The image sensor array comprises a plurality of sensing elements. The plurality of sensing elements receive incident light in a sensing region according to a plurality of different exposure times to generate a plurality of image signals. The sensing region is divided into a plurality of sub-regions along a vertical direction, and two adjacent sub-regions correspond to different exposure times. The readout circuit receives and processes the plurality of image signals to generate image data with multiple exposure times. The control logic receives the image data with multiple exposure times, calculates a plurality of average luminance values according to the image data with multiple exposure times, and determines an optimal exposure time according to the plurality of average luminance values. Each average luminance value corresponds to one of the plurality of different exposure times.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows an exemplary flowchart of the image processing method according to an embodiment of the invention.

FIG. 2 is a schematic diagram illustrating the proposed image processing according to an embodiment of the invention.

FIG. 3 shows an exemplary block diagram of an image processing system according to an embodiment of the invention.

FIG. 4 shows an exemplary block diagram of an image processing system according to another embodiment of the invention.

FIG. 5 shows an exemplary block diagram of an image processing system according to another embodiment of the invention.

FIG. 6 shows an exemplary timing diagram of automatic exposure in existing technology.

FIG. 7 shows an exemplary timing diagram of fast AE according to an embodiment of the invention.

### DETAILED DESCRIPTION

Generally, without pre-measurement, the default exposure time of an image sensor within an image capture device (such as a camera) cannot directly meet the exposure requirements of the current shooting environment. Therefore, the luminance (or, brightness) of the first frame (or, the first image) output by the image sensor in the very beginning after the image sensor starts to operate is typically incorrect, and calculations by a backend processor based on the image data output by the image sensor are required, for the luminance deviation to gradually converge. The calculations will be repeatedly performed until the luminance of the image data output by the image sensor is correct. However, this operation usually takes time of multiple frames, consequently creating a non-negligible delay, which is typically referred to as automatic exposure delay (AE delay).

To shorten the AE delay, an image processing method that can effectively achieve fast AE is proposed. By applying the proposed image processing method, the first frame output by the image sensor is the frame with correct luminance. Note that in the embodiments of the invention, the exposure time means a duration or a period of time to perform exposure.

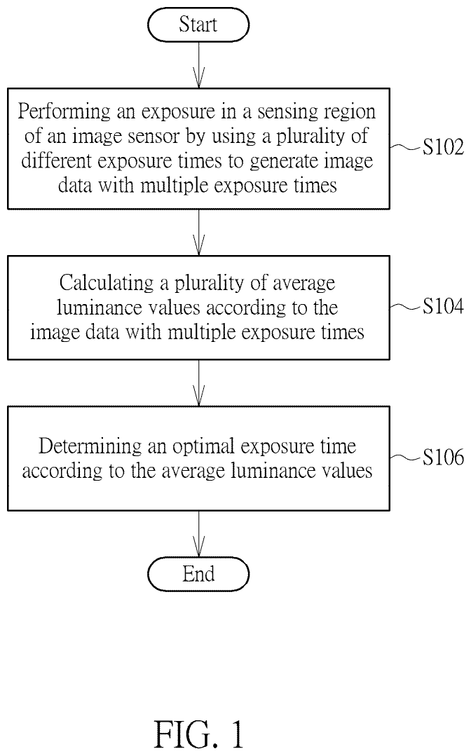

FIG. 1 shows an exemplary flowchart of the image processing method according to an embodiment of the invention. The proposed image processing method comprises the following steps:

Step S102: performing an exposure in a sensing region of an image sensor by using a plurality of different exposure times to generate image data with multiple exposure times.

According to an embodiment of the invention, the sensing region of the image sensor may be divided into a plurality of sub-regions along a vertical direction. Each sub-region may comprise one or more lines extending in a horizontal direction, and two adjacent sub-regions correspond to different exposure times.

According to an embodiment of the invention, the vertical direction is the column direction of the image sensor array, or the direction to output sensing signals or image signals generated by the image sensor, or a direction that defines image height or frame height. Conversely, the row direction of the image sensor array is the horizontal direction of the image or frame, or a direction that defines image width or frame width. A line of the image sensor or image sensor array may be a row of horizontally arranged pixels, where each pixel may correspond to one or more sensing elements of the image sensor.

Moreover, in an embodiment of the invention, step S102 may be achieved by controlling multiple sensing elements of the image sensor to receive incident light according to different exposure times.

Step S104: calculating a plurality of average luminance values according to the image data with multiple exposure times. According to an embodiment of the invention, an average luminance value of the image data obtained under each exposure time may be calculated. Therefore, in this embodiment, one average luminance value may correspond to one of the different exposure times.

Step S106: determining an optimal exposure time according to the average luminance values.

It should be noted that the proposed image processing method uses a method or a processing of “multiple exposure at once” (which may also be referred to as Multiple-Line Auto Exposure (MLAE) to obtain image data with multiple exposure times. Therefore, before the image sensor outputs image data with correct luminance, there is no need to capture multiple frames or perform repeated calculations for luminance deviation to be converged. The image sensor only needs to perform one exposure operation to obtain image data shot under different exposure times (i.e., the aforementioned image data with multiple exposure times), and determine the optimal exposure time according to the image data with multiple exposure times and the corresponding multiple exposure times. Thus, after the image capture device is activated or enabled, the first frame (or, the first image) output by the image sensor to external devices or processors is an image with correct luminance.

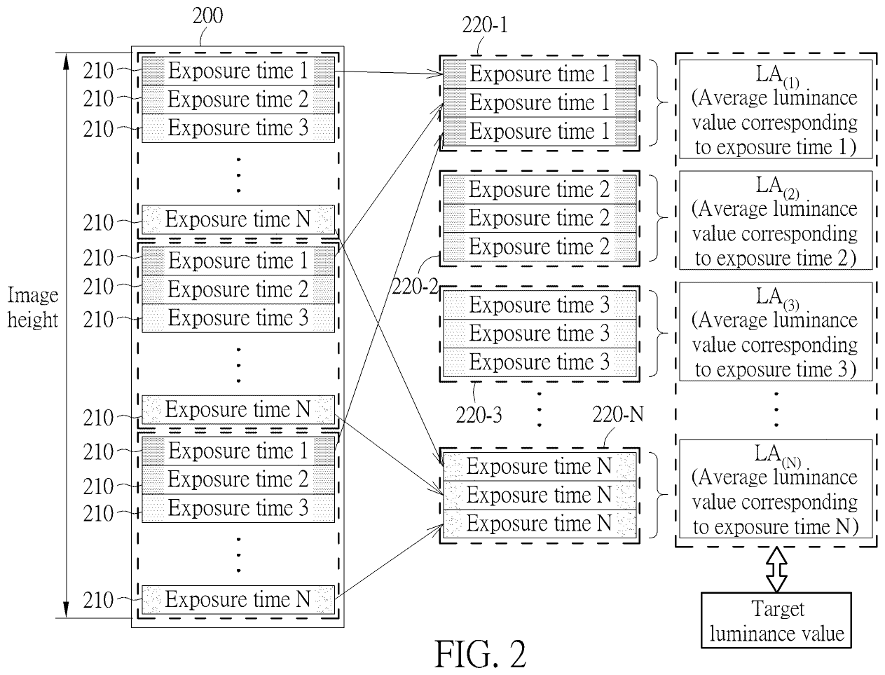

FIG. 2 is a schematic diagram illustrating the proposed image processing according to an embodiment of the invention. The sensing region of the image sensor may be defined by the image sensor array of the image sensor, for example, the sensing region 200 is comprised in the area where the image sensor array is set. According to an embodiment of the invention, sensing region 200 may be divided into a plurality of sub-regions 210 along the image height direction. Each sub-region 210 may comprise one or more lines of the image sensor or image sensor array, and different exposure times may be sequentially assigned to the sub-regions 210.

According to an embodiment of the invention, two adjacent sub-regions correspond to different exposure times (that is, for two adjacent sub-regions, different exposure times will be assigned). In addition, according to an embodiment of the invention, the same exposure time will be assigned to multiple non-adjacent sub-regions in the sensing region 200.

In an embodiment of the invention, assuming that a combination of multiple exposure times comprises N different exposure times, and configuration of each exposure time is repeated M times in the sensing region 200, the sensing region 200 may be divided into at least M*N sub-regions 210.

According to an embodiment of the invention, different exposure times may be sequentially assigned to these sub-regions in a cyclic manner. According to an embodiment of the invention, different exposure times are arranged among sub-regions in an interleaved manner. According to an embodiment of the invention, exposure times are repeatedly arranged among sub-regions. Taking FIG. 2 as an example, sensing region 200 may be divided into at least 3*N sub-regions 210, where N different exposure times are sequentially assigned to these sub-regions in a cyclic and interleaved manner, so that configuration of each exposure time is repeated 3 times in the sensing region 200.

After performing an exposure in the sensing region 200 by using N different exposure times, image data with multiple exposure times will be generated in the sensing region 200. Image data obtained based on the same exposure time will be collected together to calculate the corresponding average luminance value. For example, an average luminance value will be calculated according to the image data generated in a first sub-region and a second sub-region, where the first sub-region and the second sub-region correspond to the same first exposure time. Similarly, an average luminance value will be calculated according to the image data generated in a third sub-region and a fourth sub-region, where the third sub-region and the fourth sub-region correspond to the same second exposure time.

Referring to FIG. 2 for an example, the image data generated in sub-regions corresponding to exposure time 1 will be collected to form a sub-image 220-1, and the corresponding average luminance value LA₍₁₎ will be calculated. Similarly, the image data generated in sub-regions corresponding to exposure time 2 will be collected to form a sub-image 220-2 and the corresponding average luminance value LA₍₂₎ will be calculated, and the image data generated in sub-regions corresponding to exposure time 3 will be collected to form a sub-image 220-3 and the corresponding average luminance value LA₍₃₎ will be calculated. Likewise, the image data generated in sub-regions corresponding to exposure time N will be collected to form a sub-image 220-N and the corresponding average luminance value LA_{(N)} will be calculated, and so on.

The obtained average luminance values LA₍₁₎ to LA_{(N)} will be compared with a target luminance value (e.g., an expected luminance or an expected brightness) to determine the optimal exposure time. More specifically, between which two average luminance values the target luminance value lies or which average luminance value is the target luminance value closest to may be determined first, and then the optimal exposure time may be derived through interpolation or extrapolation.

In one embodiment of the invention, assuming that the two average luminance values close to the target luminance value are determined to be the average luminance value LA₍ₙ₎ corresponding to exposure time n and the average luminance value LA₍ₙ₋₁₎ corresponding to exposure time (n−1) (for example, the target luminance value lies between the average luminance values LA₍ₙ₎ and LA₍ₙ₋₁₎), where n is a positive integer and 1<n≤N, an interpolation operation may be performed according to the average luminance value LA₍ₙ₎, the average luminance value LA₍ₙ₋₁₎, the exposure time n, the exposure time (n−1) and the target luminance value. The following equation Eq. (1) provides an example of an interpolation operation:

$$Eq . ( 1 )$$

$${expo}_{( n - 1 )} + [ ( {expo}_{( n )} - {expo}_{( n - 1 )} ) * ( Target - {LA}_{( n - 1 )} ) ] / ( {LA}_{{( n )}^{-}} {LA}_{( n - 1 )} )$$

where the term “Target” represents the target luminance value, the term “expo₍ₙ₋₁₎” represents the exposure time (n−1), the term “expo₍ₙ₎” represents the exposure time n, and the exposure time n is longer than exposure time (n−1).

In another embodiment of the invention, assuming that the average luminance value closest to the target luminance value is determined to be the average luminance value LA₍ₘ₎ corresponding to exposure time (m), where m is a positive integer and 1<m≤N, an extrapolation operation may be performed according to the average luminance value LA₍ₘ₎, the exposure time m and the target luminance value. The following equation Eq. (2) provides an example of an extrapolation operation:

$$( Target * {expo}_{( m )} ) / {LA}_{( m )} \qquad Eq . ( 2 )$$

where the term “expo₍ₘ₎” represents the exposure time m.

It should be noted that equations (1) and (2) respectively represent one embodiment of interpolation and extrapolation operations applicable to the invention, and the invention is not limited thereto. In other embodiments of the invention, different interpolation and extrapolation operations, or other operations, may also be applied to derive the optimal exposure time.

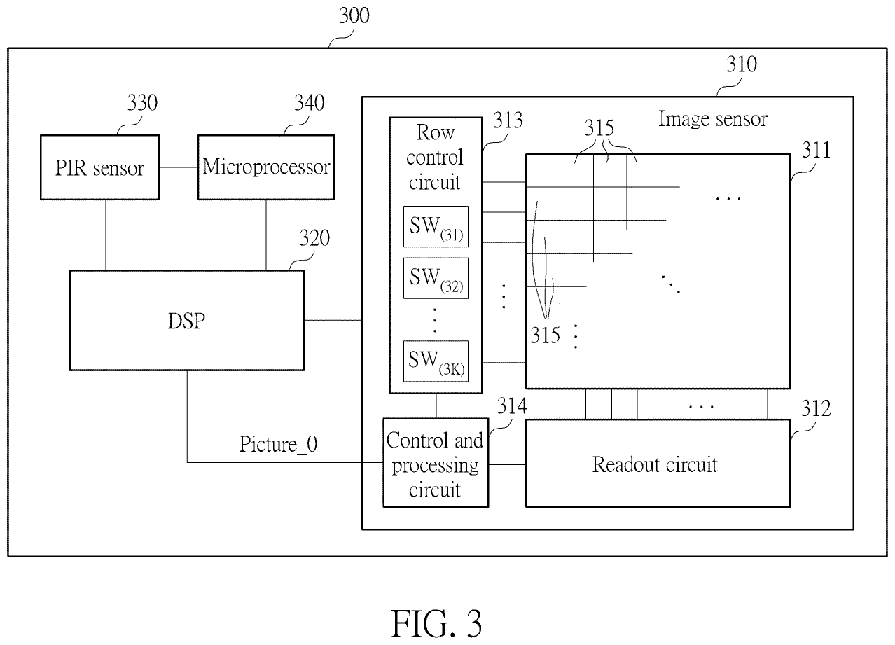

FIG. 3 shows an exemplary block diagram of an image processing system according to an embodiment of the invention. The image processing system 300 may comprise an image sensor 310, a Digital Signal Processor (DSP) 320, a PIR sensor 330, and a microprocessor 340. The image sensor 310 may be the image sensor within an image capture device. To simplify the description and drawing, only components related to the invention are shown in FIG. 3. Those skilled in the art will understand that the image processing system may further comprise other components not shown in the FIG. 3.

According to an embodiment of the invention, the PIR sensor 330 may be used to detect the occurrence of specific events and generate a detection signal when a specific event is detected. The PIR sensor 330 may detect a specific event by monitoring infrared variations in the environment. For example, the PIR sensor 330 may sense object movement by detecting changes in infrared radiation emitted by objects. When the PIR sensor 330 detects a specific event to have occurred, such as an object entering or approaching the detection area, a detection signal is generated to startup, enable, wake up, or activate (hereinafter collectively use the word “activate” as a representative) at least one of the image sensor 310, DSP 320, and microprocessor 340.

In one embodiment of the invention, the PIR sensor 330 may send the detection signal to the DSP 320, to activate the DSP 320 and trigger the DSP 320 to activate the image sensor 310, for example, by supplying power to the image sensor 310, to startup or enable the image sensor 310. In response to activation from the DSP 320, the image sensor 310 begins operation and starts performing the proposed image processing method.

In another embodiment of the invention, the PIR sensor 330 may send the detection signal to the microprocessor 340 to activate the microprocessor 340. Then, the microprocessor 340 may activate the DSP 320 to trigger the DSP 320 to activate the image sensor 310, for example, by supplying power to the image sensor 310, to startup or enable the image sensor 310. In response to activation from the DSP 320, the image sensor 310 begins operation and starts performing the proposed image processing method.

In yet another embodiment of the invention, the PIR sensor 330 may send the detection signal to both the microprocessor 340 and the DSP 320, to activate the microprocessor 340 and the DSP 320 at the same time, so as to trigger the microprocessor 340 or the DSP 320 to activate the image sensor 310, for example, by supplying power to the image sensor 310 to startup or enable the image sensor 310. In response to this activation, the image sensor 310 begins operation and starts performing the proposed image processing method.

In the embodiments of the invention, the image sensor 310 may quickly acquire image data with multiple exposure times through the processing of multiple exposure at once, which significantly accelerating the determination of optimal exposure time and enabling the image capture device to start real-time photography or video recording with the correct exposure time more quickly than existing technologies.

According to an embodiment of the invention, the image sensor 310 may comprise an image sensor array 311, a readout circuit 312, a row control circuit 313, and a control and processing circuit 314. The image sensor array 311 may comprise a plurality of sensing elements 315 arranged in a plurality of rows and columns. The sensing elements 315 may sense photons and store charges induced by the photons. The row control circuit 313 may comprise a plurality of switching devices SW₍₃₁₎, SW₍₃₂₎, . . . , SW_{(3K)} coupled to the image sensor array 311. Each switching device corresponds to one or more rows of sensing elements 315 to control the light-sensing operation of the sensing elements 315. The sensing elements 315 receive incident light in response to the on state of the corresponding switching device. The readout circuit 312 may comprise a column control circuit which provides corresponding control signals to control each column of sensing elements 315 and receives the image signals generated by the sensing elements 315. The control and processing circuit 314 may control the operations of the readout circuit 312 and the row control circuit 313 in response to control signals from the DSP 320.

According to an embodiment of the invention, the image processing system 300 may comprise a control logic. The control logic may output a plurality of control signals based on different exposure times, to respectively control start time and end time of the on state of the switching devices SW₍₃₁₎, SW₍₃₂₎, . . . , SW_{(3K)} according to the different exposure times, thereby controlling the sensing elements 315 to receive incident light according to multiple different exposure times in the sensing region and to accordingly generate a plurality of image signals. In this embodiment, the control logic may be implemented within the DSP 320.

The readout circuit 312 may receive and process the image signals generated in the sensing region to generate image data with multiple exposure times and output the image data to the control logic (for simplicity, hereinafter using DSP 320 as a representative for the control logic). In some embodiments, the image data with multiple exposure times may be provided to the DSP 320 through the control and processing circuit 314.

As described above, in an embodiment of the invention, the sensing region is divided into a plurality of sub-regions along the vertical direction, where each sub-region may comprise one or more lines extending in the horizontal direction. Adjacent sub-regions correspond to different exposure times, and non-adjacent sub-regions may correspond to the same exposure time. Moreover, different exposure times may be sequentially assigned to these sub-regions in a cyclic manner, or arranged interleaved among sub-regions, or repeatedly arranged among sub-regions.

According to an embodiment of the invention, the DSP 320 may determine or control the division of sub-regions of the image sensor 310, and accordingly control the exposure time corresponding to each sub-region, for example, by controlling the on state of switching devices SW₍₃₁₎, SW₍₃₂₎, . . . , SW_{(3K)} as mentioned above, to implement the proposed image processing method, enabling the image sensor 310 to rapidly acquire image data with multiple exposure times through the processing of multiple exposure at once.

Furthermore, according to an embodiment of the invention, the DSP 320 may receive image data with multiple exposure times and calculate a plurality of average luminance values according to this image data with multiple exposure times. In an embodiment of the invention, image data obtained based on the same exposure time will be collected, for example, forming a sub-image, to calculate the corresponding average luminance value, where each average luminance value corresponds to one of the different exposure times. The DSP 320 may further determine an optimal exposure time according to the average luminance values. Detailed explanations regarding the division of sub-regions, configuration of exposure times, and calculation of average luminance value and optimal exposure time may refer to the image processing illustrated in FIG. 2 and descriptions in the corresponding paragraphs, and will be omitted here for brevity.

The DSP 320 may control the exposure operation of the image sensor array 311 directly based on the optimal exposure time, or provide the determination result of the optimal exposure time to the control and processing circuit 314, for the control and processing circuit 314 to directly control the exposure operation of the image sensor array 311 based on the optimal exposure time. As a result, the first frame output by the image sensor 310 to the DSP 320 will be an image or frame with correct luminance, for example, the first frame Picture_0 with correct luminance shown in FIG. 3.

Unlike existing technologies in which the image sensor has to capture multiple frames to perform automatic exposure before outputting an image or frame with correct luminance, in the embodiments of the invention, by implementing the proposed image processing method, after the image capture device is activated or enabled, the image sensor 310 rapidly completes fast AE and the optimal exposure time is determined via multiple exposure at once, allowing the image sensor 310 to directly and quickly output the first frame with correct luminance.

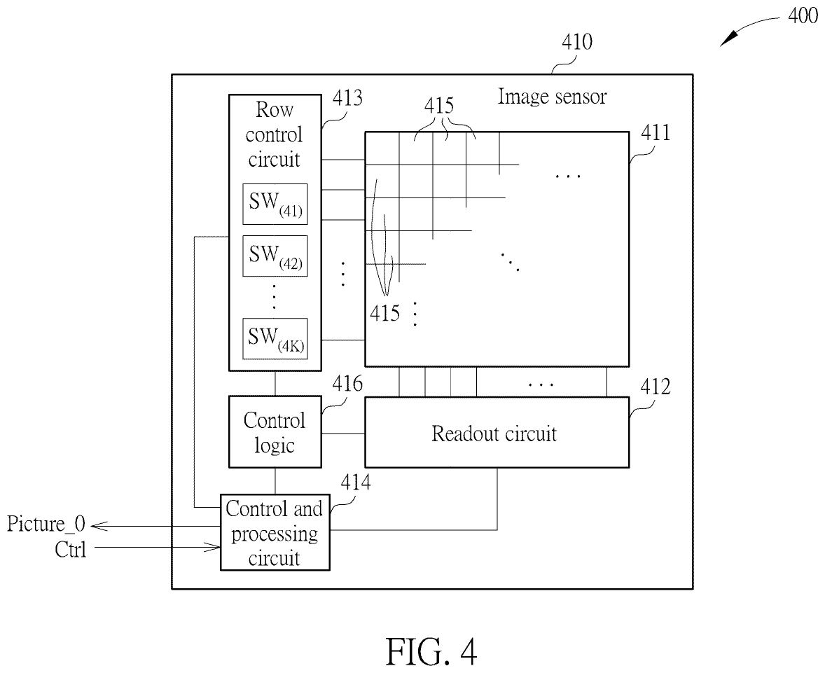

FIG. 4 shows an exemplary block diagram of an image processing system according to another embodiment of the invention. The image processing system 400 may comprise an image sensor 410. The image sensor 410 may be the image sensor within an image capture device. To simplify the description and drawing, only components related to the invention are shown in FIG. 4. Those skilled in the art will understand that the image processing system may further comprise other components not shown in the FIG. 4.

According to an embodiment of the invention, the image sensor 410 may be activated and start operating in response to a control signal Ctrl from an external circuit (such as, but not limited to, the aforementioned DSP, microprocessor, or PIR sensor), and start performing the proposed image processing method.

In the embodiments of the invention, the image sensor 410 may quickly acquire image data with multiple exposure times through the processing of multiple exposure at once, which significantly accelerating the determination of optimal exposure time and enabling the image capture device to start real-time photography or video recording with the correct exposure time more quickly than existing technologies.

According to an embodiment of the invention, the image sensor 410 may comprise an image sensor array 411, a readout circuit 412, a row control circuit 413, and a control and processing circuit 414. The image sensor array 411 may comprise a plurality of sensing elements 415 arranged in a plurality of rows and columns. The sensing elements 415 may sense photons and store charges induced by the photons. The row control circuit 413 may comprise a plurality of switching devices SW₍₄₁₎, SW₍₄₂₎, . . . , SW_{(4K)} coupled to the image sensor array 411. Each switching device corresponds to one or more rows of sensing elements 415 to control the light-sensing operation of the sensing elements 415. The sensing elements 415 receive incident light in response to the on state of the corresponding switching device. The readout circuit 412 may comprise a column control circuit which provides corresponding control signals to control each column of sensing elements 415 and receives the image signals generated by the sensing elements 415. The control and processing circuit 414 may control the operations of the readout circuit 412 and the row control circuit 413 in response to the control signal from the external circuit.

According to an embodiment of the invention, the image sensor 410 may comprise a control logic 416. The control logic 416 may output a plurality of control signals based on different exposure times, to respectively control start time and end time of the on state of the switching devices SW₍₄₁₎, SW₍₄₂₎, . . . , SW_{(4K)}, thereby controlling the sensing elements 415 to receive incident light according to different exposure times in the sensing region to generate a plurality of image signals.

According to an embodiment of the invention, the control logic 416 may be an Application Specific Integrated Circuit (ASIC) and may be implemented as an independent circuit within the image sensor 410. According to another embodiment of the invention, the control logic 416 may also be implemented as a control logic circuit within the control and processing circuit 414, or the control logic 416 and control and processing circuit 414 may be integrated into one device or circuit. It should be noted that the invention is not limited to any specific implementation. Therefore, the content shown in FIG. 4 is to illustrate one embodiment of the invention and should not be a limit to the invention. For simplicity, the following paragraphs will uniformly use the control logic 416 as a representative of various possible implementations of the proposed control logic.

As described above, in an embodiment of the invention, the sensing region is divided into a plurality of sub-regions along the vertical direction, where each sub-region may comprise one or more lines extending in the horizontal direction. Adjacent sub-regions correspond to different exposure times, and non-adjacent sub-regions may correspond to the same exposure time. Moreover, different exposure times may be sequentially assigned to these sub-regions in a cyclic manner, or arranged interleaved among sub-regions, or repeatedly arranged among sub-regions.

According to an embodiment of the invention, the control logic 416 may determine or control the division of sub-regions of the image sensor 410, and accordingly control the exposure time corresponding to each sub-region, for example, by controlling the on state of switching devices SW₍₄₁₎, SW₍₄₂₎, . . . , SW_{(4K)} as mentioned above, to implement the proposed image processing method, enabling the image sensor 410 to rapidly acquire image data with multiple exposure times through the processing of multiple exposure at once.

Furthermore, according to an embodiment of the invention, the readout circuit 412 may receive and process image signals generated in the sensing region to generate image data with multiple exposure times, and output the image data with multiple exposure times to the control logic 416. The control logic 416 may receive image data with multiple exposure times and calculate a plurality of average luminance values according to the image data with multiple exposure times. In an embodiment of the invention, image data obtained based on the same exposure time will be collected, for example, forming a sub-image, to calculate the corresponding average luminance value, where each average luminance value corresponds to one of the different exposure times. The control logic 416 may further determine an optimal exposure time according to the average luminance values. Detailed explanations regarding the division of sub-regions, configuration of exposure times, and calculation of average luminance value and optimal exposure time may refer to the image processing illustrated in FIG. 2 and descriptions in the corresponding paragraphs, and will be omitted here for brevity.

The control logic 416 may provide the determination result of the optimal exposure time to the control and processing circuit 414, for the control and processing circuit 414 to directly control the exposure operation of the image sensor array 411 based on the optimal exposure time. As a result, the first frame output by the image sensor 410 will be an image or frame with correct luminance, for example, the first frame Picture_0 with correct luminance shown in FIG. 4.

Unlike existing technologies in which the image sensor has to capture multiple frames to perform automatic exposure before outputting an image or frame with correct luminance, in the embodiments of the invention, by implementing the proposed image processing method, after the image capture device is activated or enabled, the image sensor 410 rapidly completes fast AE and the optimal exposure time is determined via multiple exposure at once, allowing the image sensor 410 to directly and quickly output the first frame with correct luminance.

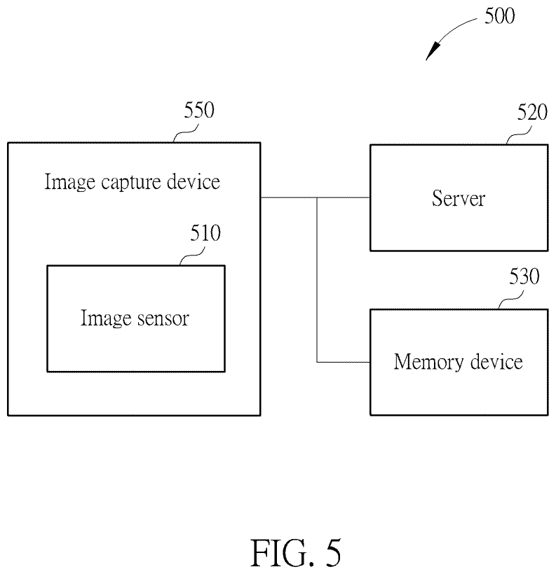

FIG. 5 shows an exemplary block diagram of an image processing system according to another embodiment of the invention. The image processing system 500 may comprise an image capture device 550. According to an embodiment of the invention, the image capture device 550 may be a camera device, such as a webcam. According to another embodiment of the invention, the image capture device 550 may also be a built-in camera device of a monitoring device, such as a hunting camera, a trail camera, a video doorbell, etc.

The image capture device 550 may comprise an image sensor 510. To simplify the description and drawing, only components related to the invention are shown in FIG. 5. Those skilled in the art will understand that the image processing system may further comprise other components not shown in FIG. 5.

According to an embodiment of the invention, different exposure times are used in the sensing region of the image sensor 510 to generate image data with multiple exposure times. As mentioned, the sensing region of the image sensor 510 is divided into a plurality of sub-regions along the vertical direction, where each sub-region may comprise one or more lines extending in the horizontal direction. Adjacent sub-regions correspond to different exposure times, and non-adjacent sub-regions may correspond to the same exposure time. Moreover, different exposure times may be sequentially assigned to these sub-regions in a cyclic manner, or arranged interleaved among sub-regions, or repeatedly arranged among sub-regions.

According to an embodiment of the invention, the image sensor 510, the image capture device 550, or other devices may calculate a plurality of average luminance values according to the image data with multiple exposure times, and determine an optimal exposure time according to the obtained average luminance values. For each exposure time, the image sensor 510, the image capture device 550, or other devices may calculate the corresponding average luminance value of image data obtained under the exposure time. Therefore, in the embodiments of the invention, each average luminance value corresponds to one of the different exposure times.

In some embodiments of the invention, the image sensor 510 may be implemented as the image sensor 310 shown in FIG. 3 or the image sensor 410 shown in FIG. 4. Therefore, the detailed operation and control of the image sensor 510 completing fast AE through the processing of multiple exposure at once may refer to the content in FIG. 2, FIG. 3 and FIG. 4 and descriptions in the corresponding paragraphs, and will be omitted here for brevity.

It should be noted that those skilled in the art may also derive other embodiments of the invention based on the content in FIG. 2, FIG. 3 and FIG. 4. Therefore, in other embodiments of the invention, the image sensor 510 may also be implemented in different ways. Under different implementations, the image sensor 510 may still perform the proposed image processing method to achieve fast AE, allowing the image sensor 510 to directly and quickly output the first frame with correct luminance.

According to one embodiment of the invention, the frame, image or video with correct luminance output by the image sensor 510 may be transmitted to a server 520 or a memory device 530 in a wired or wireless manner. Unlike existing technologies where image sensors must capture multiple frames to perform automatic exposure before outputting an image with correct luminance, in the embodiments of the invention, after the image capture device 550 is activated or enabled, the image sensor 510 completes fast AE via multiple exposure at once to determine the optimal exposure time, ensuring that the first frame output by the image sensor 510 has correct luminance.

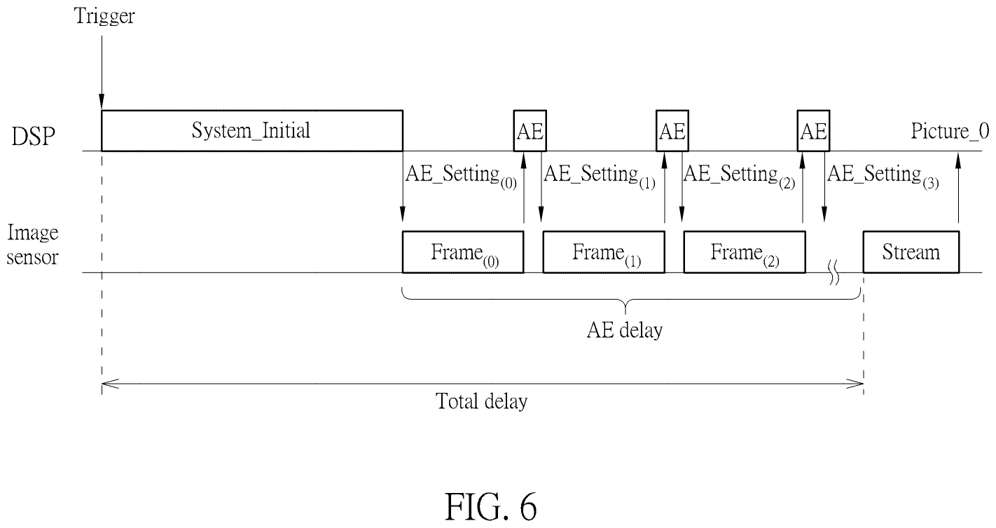

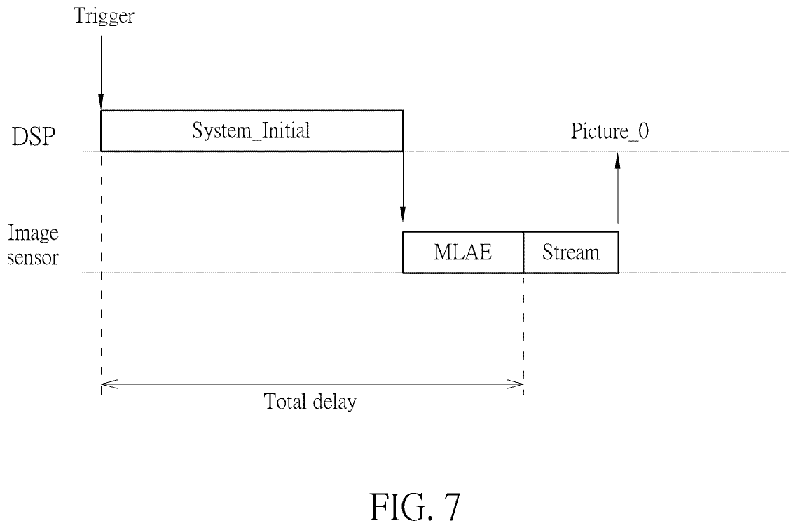

FIG. 6 shows an exemplary timing diagram of automatic exposure in existing technology. As a contrast to FIG. 7, FIG. 6 demonstrates the timing of automatic exposure performed by a DSP and an image sensor in existing technology. The DSP is activated in response to a detection signal or a trigger signal (labeled as “Trigger”), and performs operations for system initialization (labeled as “System_Initial”). After system initialization is complete, the DSP activates the image sensor, for example, by supplying power to the image sensor, and provides an initial automatic exposure setting (AE setting) AE_Setting₍₀₎ to the image sensor. The image sensor performs exposure (labeled as “AE”) with the corresponding exposure time based on the AE_Setting₍₀₎, and obtains the first image (or, first frame) Frame₍₀₎ for calibrating the exposure time. The image sensor may provide information, such as luminance information, obtained from the first image (or, first frame) Frame₍₀₎ to the DSP, for the DSP to perform AE-related calculations, accordingly adjust the automatic exposure parameters, and provide an updated AE setting AE_Setting₍₁₎ to the image sensor.

Subsequently, the image sensor performs exposure with the corresponding exposure time based on the AE_Setting₍₁₎. The image sensor obtains the second image (or, second frame) Frame₍₁₎ for calibrating the exposure time and provides the information obtained from the second image (or, second frame) Frame₍₁₎ to the DSP, for the DSP to perform AE-related calculations again. The DSP will repeatedly calculate based on the frames output by the image sensor, for the luminance deviation to be gradually converged and until the luminance of the frame output by the image sensor is correct.

When the luminance of the frame output by the image sensor is determined to be correct, the DSP accordingly determines the currently optimal exposure setting. Only after the image sensor begins to perform exposure with the optimal exposure setting will the output stream (labeled as “Stream”) comprise image data with correct luminance, and only then can the image sensor output the first frame Picture_0 with correct luminance (Note that in the drawings, Picture_0 represents the “first frame with correct luminance”).

From FIG. 6, it can be seen that the automatic exposure in existing technology typically requires the image data from multiple frames (e.g., at least Frame₍₀₎ to Frame₍₂₎) to iteratively calibrate AE settings (e.g., at least AE_Setting₍₀₎ to AE_Setting₍₃₎, thus causing AE delay. For external circuits or users waiting for the image sensor output, the total delay from issuing the trigger signal to obtaining the first frame with correct luminance is not negligible.

FIG. 7 shows an exemplary timing diagram of fast AE according to an embodiment of the invention. Similarly, the DSP is activated in response to a detection signal or a trigger signal 1 (labeled as “Trigger”), and performs operations for system initialization (labeled as “System_Initial”). After system initialization is complete, the DSP activates the image sensor, for example, by supplying power to the image sensor, enabling the image sensor to start performing the proposed image processing method to complete fast AE through the processing of multiple exposure at once (labeled as “MLAE”) to determine the currently optimal exposure setting. Then, the image sensor begins to perform exposure operation with the optimal exposure setting and may output the first frame Picture_0 with correct luminance based on the stream (labeled as “Stream”) comprise image data with correct luminance. Compared to FIG. 6, the total delay required by the proposed image processing method is significantly reduced and shorter than the existing technology. In one embodiment of the invention, under environmental luminance of 1-20,000 lux, the time from the image sensor being supplied with power to the first frame Picture_0 with correct luminance being output can be reduced to 29 milliseconds (ms), with the luminance value of the first frame falling within +2.5% of the target luminance value.

In summary, unlike existing technology where image sensors must capture multiple frames to perform automatic exposure before outputting an image or frame with correct luminance, in the embodiments of the invention, by implementing the proposed image processing method, after the image capture device is activated or enabled, the image sensor completes fast AE through the processing of multiple exposure at once to determine the optimal exposure time, allowing the image sensor to directly and quickly output the first frame with correct luminance.

This disclosure describes various embodiments of the invention through the above descriptions. It should be noted that although there are differences between the descriptions of various embodiments, those skilled in the art can still flexibly apply these differences to different embodiments based on the spirit of the invention. For example, technical content described in other embodiments but not described in a particular embodiment can be applied to this embodiment. Therefore, the scope of the invention is not limited to the embodiments disclosed above.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method, comprising:
performing an exposure in a sensing region of an image sensor by using a plurality of different exposure times to generate image data with multiple exposure times, wherein the sensing region is divided into a plurality of sub-regions along a vertical direction, and two adjacent sub-regions correspond to different exposure times;
calculating a plurality of average luminance values according to the image data with multiple exposure times, wherein each average luminance value corresponds to one of the plurality of different exposure times; and
determining an optimal exposure time according to the plurality of average luminance values.

2. The image processing method of claim 1, wherein the plurality of different exposure times are sequentially assigned to the plurality of sub-regions in a cyclic manner.

3. The image processing method of claim 1, wherein two non-adjacent sub-regions correspond to the same exposure time.

4. The image processing method of claim 1, wherein step of performing the exposure in the sensing region of the image sensor by using the plurality of different exposure times to generate the image data with multiple exposure times further comprises:
controlling a plurality of sensing elements of the image sensor to receive incident light according to the plurality of different exposure times.

5. The image processing method of claim 1, wherein the plurality of different exposure times comprise a first exposure time and a second exposure time, and wherein step of calculating the plurality of average luminance values according to the image data with multiple exposure times further comprises:
calculating a first average luminance value according to image data generated in a first sub-region and a second sub-region, wherein the first sub-region and the second sub-region correspond to the first exposure time; and
calculating a second average luminance value according to image data generated in a third sub-region and a fourth sub-region, wherein the third sub-region and the fourth sub-region correspond to the second exposure time.

6. The image processing method of claim 1, wherein step of determining the optimal exposure time according to the plurality of average luminance values further comprises:
determining a first average luminance value and a second average luminance value that are close to a target luminance value among the plurality of average luminance values, wherein the first average luminance value corresponds to a first exposure time, and the second average luminance value corresponds to a second exposure time; and
performing an interpolation operation according to the first average luminance value, the second average luminance value, the first exposure time, the second exposure time, and the target luminance value to determine the optimal exposure time.

7. The image processing method of claim 1, wherein step of determining the optimal exposure time according to the plurality of average luminance values further comprises:
determining a first average luminance value that is closest to a target luminance value among the plurality of average luminance values, wherein the first average luminance value corresponds to a first exposure time; and
performing an extrapolation operation according to the first average luminance value, the first exposure time, and the target luminance value to determine the optimal exposure time.

8. An image sensor, comprising:
an image sensor array, comprising a plurality of sensing elements, wherein the plurality of sensing elements receive incident light in a sensing region according to a plurality of different exposure times to generate a plurality of image signals, the sensing region is divided into a plurality of sub-regions along a vertical direction, and two adjacent sub-regions correspond to different exposure times;
a readout circuit, receiving and processing the plurality of image signals to generate image data with multiple exposure times; and
a control logic, receiving the image data with multiple exposure times, calculating a plurality of average luminance values according to the image data with multiple exposure times, and determining an optimal exposure time according to the plurality of average luminance values, wherein each average luminance value corresponds to one of the plurality of different exposure times.

9. The image sensor of claim 8, wherein the plurality of different exposure times are sequentially assigned to the plurality of sub-regions in a cyclic manner.

10. The image sensor of claim 8, wherein two non-adjacent sub-regions correspond to the same exposure time.

11. The image sensor of claim 8, further comprising:
a plurality of switching devices, coupled to the image sensor array and corresponding to the plurality of sensing elements, wherein the plurality of sensing elements receive incident light in response to an on state of the plurality of switching devices, and
wherein the control logic controls start time and end time of the on state of the plurality of switching devices according to the plurality of different exposure times.

12. The image sensor of claim 8, wherein the plurality of different exposure times comprise a first exposure time and a second exposure time, the plurality of sub-regions comprise a first sub-region, a second sub-region, a third sub-region, and a fourth sub-region, the first sub-region and the second sub-region correspond to the first exposure time, the third sub-region and the fourth sub-region correspond to the second exposure time, and in operation of calculating the plurality of average luminance values according to the image data with multiple exposure times, the control logic calculates a first average luminance value according to image data generated in the first sub-region and the second sub-region, and calculates a second average luminance value according to image data generated in the third sub-region and the fourth sub-region.

13. The image sensor of claim 8, wherein in operation of determining the optimal exposure time according to the plurality of average luminance values, the control logic determines a first average luminance value and a second average luminance value that are close to a target luminance value among the plurality of average luminance values, and performs an interpolation operation according to the first average luminance value, the second average luminance value, a first exposure time corresponding to the first average luminance value, a second exposure time corresponding to the second average luminance value, and the target luminance value to determine the optimal exposure time.

14. The image sensor of claim 8, wherein in operation of determining the optimal exposure time according to the plurality of average luminance values, the control logic determines a first average luminance value that is closest to a target luminance value among the plurality of average luminance values, and performs an extrapolation operation according to the first average luminance value, a first exposure time corresponding to the first average luminance value, and the target luminance value to determine the optimal exposure time.
